(19) United States
(12) Patent Application Publication
(10) Pub. No.: US 2025/0183364 A1
(43) Pub. Date: Jun. 5, 2025

(54) SOLID STATE BATTERY AND METHOD FOR PRODUCING SOLID STATE BATTERY

(71) Applicants: TOYOTA JIDOSHA KABUSHIKI KAISHA, Toyota-shi (JP); IDEMITSU KOSAN CO., LTD., Tokyo (JP)

(72) Inventors: Toru KIDOSAKI, Miyoshi-shi (JP); Yusuke ISEKI, Chiba-shi (JP)

(73) Assignees: TOYOTA JIDOSHA KABUSHIKI KAISHA, Toyota-shi (JP); IDEMITSU KOSAN CO., LTD., Tokyo (JP)

(21) Appl. No.: 18/964,092

(22) Filed: Nov. 29, 2024

(30) Foreign Application Priority Data
Dec. 4, 2023 (JP) 2023-204471

(51) Int. Cl. H01M 10/0562; H01M 4/02; H01M 4/38; H01M 4/525; H01M 10/058

(52) U.S. Cl. CPC H01M 10/0562; H01M 4/386; H01M 4/525; H01M 10/058; H01M 2004/027; H01M 2004/028; H01M 2300/0068; H01M 2300/0082; H01M 2300/0094

(57) ABSTRACT

A solid state battery includes a cathode active material layer, an anode active material layer, and a solid electrolyte layer arranged between the cathode active material layer and the anode active material layer, wherein the cathode active material layer, the anode active material layer, and the solid electrolyte layer contain a coated sulfide solid electrolyte as an electrolyte; the coated sulfide solid electrolyte includes a sulfide solid electrolyte containing at least a Li element, a S element, and a P element, and a coating layer that covers a surface of the sulfide solid electrolyte and contains a modifier; and the modifier is at least one kind of, a compound represented by the general formula (1), a compound represented by the general formula (2), a polymer of the compound represented by the general formula (1), and a polymer of the compound represented by the general formula (2).

### TECHNICAL FIELD

The present disclosure relates to a solid state battery, and a method for producing the solid state battery.

### BACKGROUND ART

A solid state battery is a battery including a solid electrolyte layer between a cathode and an anode, and one of the advantages thereof is that the simplification of a safety device may be more easily achieved compared to a liquid-based battery including a liquid electrolyte containing a flammable organic solvent. Also, as a solid electrolyte used for a solid state battery, sulfide solid electrolytes have been known.

For example, Patent Literature 1 discloses a method for producing a composite solid electrolyte formed by covering a surface of a sulfide solid electrolyte with a coating material. Also, Patent Literature 2 discloses a modified sulfide solid electrolyte, of which BET specific surface area is 10 m²/g or more, the modified sulfide solid electrolyte including a sulfide solid electrolyte including a lithium atom, a sulfur atom, a phosphorus atom and a halogen atom, and an epoxy compound, wherein the modified sulfide solid electrolyte includes a peak at 2800 to 3000 cm⁻¹ in an infrared ray absorption spectrum by a FT-IR analysis (ATR method).

### CITATION LIST

### Patent Literatures

Patent Literature 1: Japanese Patent Application Laid-Open (JP-A) No. 2020-087633
Patent Literature 2: International Application Publication: WO 2022/158458

### Summary of Disclosure

### Technical Problem

The Li ion conductivity of a sulfide solid electrolyte is easily degraded by moisture (such as moisture in the atmosphere). For this reason, a solid state battery containing the sulfide solid electrolyte is easily deteriorated by moisture.

The present disclosure has been made in view of the above circumstances and a main object thereof is to provide a solid state battery of which deterioration due to moisture is suppressed.

### Solution to Problem

[1]

A solid state battery comprising a cathode active material layer, an anode active material layer, and a solid electrolyte layer arranged between the cathode active material layer and the anode active material layer, wherein
the cathode active material layer, the anode active material layer, and the solid electrolyte layer contain a coated sulfide solid electrolyte as an electrolyte;
the coated sulfide solid electrolyte includes a sulfide solid electrolyte containing at least a Li element, a S element, and a P element, and a coating layer that covers a surface of the sulfide solid electrolyte and contains a modifier; and
the modifier is at least one kind of, a compound represented by the below general formula (1), a compound represented by the below general formula (2), a polymer of the compound represented by the below general formula (1), and a polymer of the compound represented by the below general formula (2).

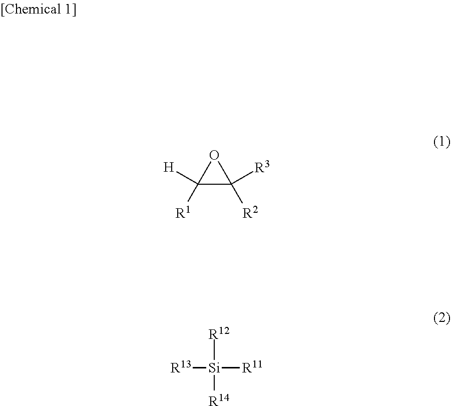

In the formula (1), R¹ to R³ are each independently a hydrogen atom, a halogen atom, a univalent hydrocarbon group or a univalent halogenated hydrocarbon group, at least one of R¹ to R³ is a univalent hydrocarbon group or a univalent halogenated hydrocarbon group, and at least one of R¹ to R³ includes an ether structure.

In the formula (2), R¹¹ to R¹⁴ are each independently a hydrogen atom, a halogen atom, a univalent silyl ether group, a univalent hydrocarbon group or a univalent halogenated hydrocarbon group, and at least one of R¹¹ to R¹⁴ is a silyl ether group.

[2]

The solid state battery according to [1], wherein a proportion of the modifier with respect to the sulfide solid electrolyte is 12.5 mass % or less.

[3]

The solid state battery according to [1] or [2], wherein a proportion of the modifier with respect to the sulfide solid electrolyte is 10.0 mass % or less.

[4]

The solid state battery according to any one of [1] to [3], wherein the modifier is at least one of the compound represented by the general formula (1) and the polymer of the compound represented by the general formula (1), among R¹ to R³, two are the hydrogen atom, and one is the univalent hydrocarbon group including the ether structure.

[5]

The solid state battery according to any one of [1] to [4], wherein the modifier is at least one of the compound represented by the general formula (2) and the polymer of the compound represented by the general formula (2), among R¹¹ to R¹⁴, three are the univalent silyl ether group, and one is the univalent hydrocarbon group.

[6]

The solid state battery according to any one of [1] to [5], wherein the modifier is at least one kind of, the below compound A, the below compound B, the below compound C, the below compound D, a polymer including at least one of the below compound A and the below compound B, and a polymer including at least one of the below compound C and the below compound D.

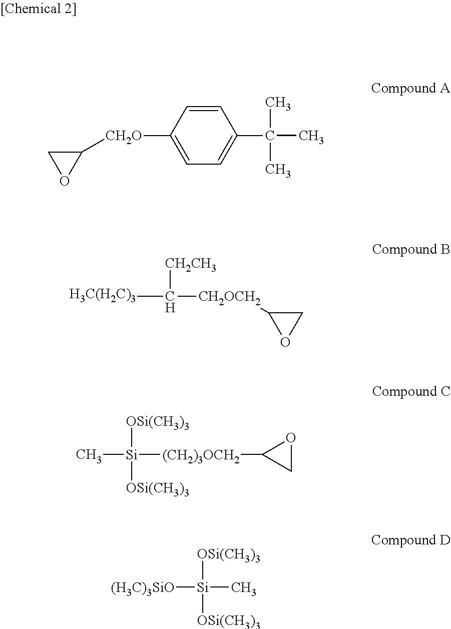

[7]

The solid state battery according to [6], wherein the modifier is the compound A, the compound B or the compound C.

[8]

The solid state battery according to any one of [1] to [7], wherein a molecular weight or a weight average molecular weight of the modifier is 60 or more.

[9]

The solid state battery according to any one of [1] to [8], wherein, in each of the cathode active material layer, the anode active material layer, and the solid electrolyte layer, a proportion of the coated sulfide solid electrolyte with respect to a total of the electrolyte is 50 mass % or more and 100 mass % or less.

A method for producing the solid state battery according to any one of [1] to [9], the method comprising:
a preparing step of preparing the coated sulfide solid electrolyte; and
a layer forming step of forming the cathode active material layer, the anode active material layer, and the solid electrolyte layer, using the coated sulfide solid electrolyte, wherein
the layer forming step is performed under an environment with a dew point temperature of −50° C. or more.

The method for producing the solid state battery according to [10], wherein the layer forming step is performed under an environment with a dew point temperature of −30° C. or less.

### Advantageous Effects of Disclosure

The present disclosure exhibits an effect of providing a solid state battery of which deterioration due to moisture is suppressed.

### BRIEF DESCRIPTION OF DRAWINGS

FIG. 1 is a schematic cross-sectional view exemplifying the solid state battery in the present disclosure.

### DESCRIPTION OF EMBODIMENTS

The solid state battery, and the method for producing the solid state battery in the present disclosure will be hereinafter explained in details. Each drawing described as below is a schematic view, and the size and the shape of each portion are appropriately exaggerated in order to be understood easily.

### A. Solid State Battery

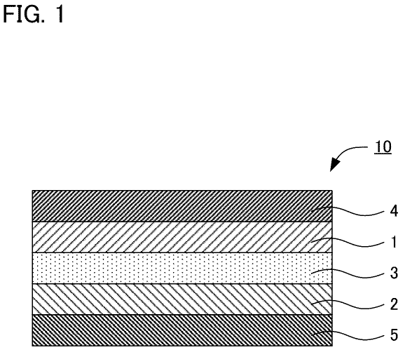

FIG. 1 is a schematic cross-sectional view exemplifying the solid state battery in the present disclosure. Solid state battery 10 shown in FIG. 1 includes cathode active material layer 1, anode active material layer 2, and solid electrolyte layer 3 arranged between the cathode active material layer 1 and the anode active material layer 2. Also, the solid state battery 10 usually includes cathode current collector 4 for collecting electrons of the cathode active material layer 1, and anode current collector 5 for collecting electrons of the anode active material layer 2. Particularly in the solid state batter 10, the cathode active material layer 1, the anode active material layer 2, and the solid electrolyte layer 3 contain a specified coated sulfide solid electrolyte as an electrolyte.

According to the present disclosure, the cathode active material layer, the anode active material layer, and the solid electrolyte layer contain the specified coated sulfide solid electrolyte as the electrolyte, and thus the deterioration of the solid state battery due to moisture is suppressed.

### 1. Coated Sulfide Solid Electrolyte

In the solid state battery in the present disclosure, the cathode active material layer, the anode active material layer, and the solid electrolyte layer contain a coated sulfide solid electrolyte as an electrolyte.

The coated sulfide solid electrolyte includes a sulfide solid electrolyte, and a coating layer that covers a surface of the sulfide solid electrolyte and contains a modifier.

### (1) Sulfide Solid Electrolyte

The sulfide solid electrolyte contains at least a Li element, a S element, and a P element. Also, the sulfide solid electrolyte may further contain at least one of an O element and a halogen element (for example, at least one kind of a F element, a Cl element, a Br element, and an I element).

The sulfide solid electrolyte preferably contains sulfur(S) as a main component of the anion element.

Examples of the sulfide solid electrolyte may include Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (provided that m, n is a positive number; Z is any one of Ge, Zn, and Ga), Li₂S—GeS₂, Li₂S—SiS₂—Li₃PO₄, and Li₂S—SiS₂-LiₓMO_{y} (provided that x, y is a positive number; M is any one of P, Si, Ge, B, Al, Ga, and In).

The sulfide solid electrolyte may include, for example, a composition represented by xLi₂S·(100-x) P₂S₅ (70≤x≤80), and yLiI·zLiBr·(100-y-z)(xLi₂S·(1-x)P₂S₅)(0.7≤x≤0.8, 0≤y≤30, 0≤z≤30).

Also, the sulfide solid electrolyte may include a composition represented by the below general formula (1):

Li₄₋ₓGe₁₋ₓPₓS₄(0<x<1) Formula (1).

In the formula (1), at least a part of Ge may be substituted with at least one selected from the group consisting of Sb, Si, Sn, B, Al, Ga, In, Ti, Zr, V and Nb. Also, at least a part of P may be substituted with at least one selected from the group consisting of Sb, Si, Sn, B, Al, Ga, In, Ti, Zr, V and Nb. A part of Li may be substituted with at least one selected from the group consisting of Na, K, Mg, Ca and Zn. A part of S may be substituted with a halogen. The halogen is at least one of F, Cl, Br, and I.

The kinds of atoms configuring the sulfide solid electrolyte can be confirmed by, for example, an ICP emission spectrophotometer.

The sulfide solid electrolyte may be an amorphous sulfide solid electrolyte such as a glass-based sulfide solid electrolyte (sulfide glass). Also, the sulfide solid electrolyte may be a crystalline sulfide solid electrolyte such as a glass ceramic-based sulfide solid electrolyte. The crystalline sulfide solid electrolyte can be obtained by heating an amorphous sulfide solid electrolyte to the crystallization temperature or more.

Examples of the crystal structure included in the crystalline sulfide solid electrolyte may include a Li₃PS₄ crystal structure, a Li₄P₂S₆ crystal structure, a Li₇PS₆ crystal structure, a Li₇P₃S₁₁ crystal structure, and a crystal structure having a peak in the vicinity of 2θ=20.2° and 23.6° (for example, JP-A No. 2013-16423). Also, other examples of the crystal structure may include a Li₄-ₓGe₁₋ₓPₓS₄-based thio-LISICON Region II type crystal structure (see Kanno et. Al., Journal of The Electrochemical Society, 148 (7) A742-746 (2001)), and a crystal structure similar to the Li₄₋ₓGe₁₋ₓPₓS₄-based thio-LISICON Region II type crystal structure (see Solid State Ionics, 177 (2006), 2721-2725).

There are no particular limitations on the shape of the sulfide solid electrolyte, and examples thereof may include a granular shape. The average particle size (D₅₀) of the sulfide solid electrolyte in a granular shape is, for example, 0.01 μm or more and 500 μm or less, and may be 0.1 μm or more and 200 μm or less. The average particle size (D₅₀) refers to 50% accumulation particle size in a volume-based particle distribution by a laser diffraction particle distribution measurement device.

### (2) Coating Layer

The coating layer covers a surface of the sulfide solid electrolyte and contains a specified modifier.

The modifier is at least one kind of, a compound represented by the below general formula (1), a compound represented by the below general formula (2), a polymer of the compound represented by the below general formula (1), and a polymer of the compound represented by the below general formula (2). That is, the coating layer may contain one kind of the modifier, and may contain two kinds or more of the modifier.

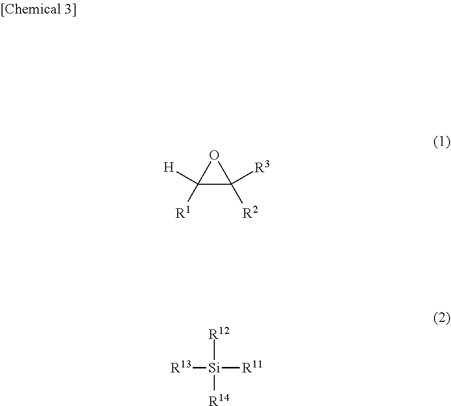

In the formula (1), R¹ to R³ are each independently a hydrogen atom, a halogen atom, a univalent hydrocarbon group or a univalent halogenated hydrocarbon group, at least one of R¹ to R³ is a univalent hydrocarbon group or a univalent halogenated hydrocarbon group, and at least one of R¹ to R³ includes an ether structure.

In the formula (2), R¹¹ to R¹⁴ are each independently a hydrogen atom, a halogen atom, a univalent silyl ether group, a univalent hydrocarbon group or a univalent halogenated hydrocarbon group, and at least one of R¹¹ to R¹⁴ is a silyl ether group.

First, the general formula (1) will be explained. In the formula (1), examples of the halogen atom may include fluorine, chlorine, bromine, and iodine. Among these, fluorine, chlorine, and bromine are preferable, and fluorine is more preferable.

In the formula (1), the number of carbon in the univalent hydrocarbon group is, for example, 1 or more and 20 or less, may be 3 or more and 15 or less, and may be 5 or more and 10 or less. The reason therefor is from the viewpoint of suppressing the battery resistance.

Examples of the univalent hydrocarbon group may include an aliphatic hydrocarbon group, an alicyclic hydrocarbon group, and an aromatic hydrocarbon group. Among these, the aliphatic hydrocarbon group or the alicyclic hydrocarbon group is preferable, and the aliphatic hydrocarbon group is more preferable. The aliphatic hydrocarbon group may be straight chain and may be branched chain, but is preferably branched chain.

Examples of the aliphatic hydrocarbon group may include an alkyl group and an alkenyl group. Among these, the alkyl group is preferable. Examples of the alicyclic hydrocarbon group may include a cycloalkyl group and a cycloalkenyl group. Examples of the aromatic hydrocarbon group may include a phenyl group, a naphthyl group, a biphenyl group, a diphenyl methyl group, a trityl group, an anthranil group, a perylenyl group, and a pyrenyl group. A part of the aromatic hydrocarbon group may be substituted with a hydroxyl group, or the univalent aliphatic hydrocarbon group (such as the alkyl group and the alkenyl group). For example, groups such as a benzil group is also included in the aromatic hydrocarbon group in the present disclosure. Here, the hydrocarbon group is a group containing at least a carbon atom and a hydrogen atom, and may be a group further containing a hetero atom such as an oxygen atom. For example, the univalent hydrocarbon group may include at least one of an ether structure (ether group) and an epoxide structure (epoxy group).

Examples of the univalent halogenated hydrocarbon group may include a group in which a part of the univalent hydrocarbon group is substituted with a halogen atom. As the halogen atom, fluorine, chlorine, and bromine are preferable, and fluorine is more preferable.

In the general formula (1), it is preferable that, among R¹ to R³, two are hydrogen atoms, and one is the univalent hydrocarbon group including the ether structure or the univalent halogenated hydrocarbon group. Also, it is more preferable that, among R¹ to R³, two are hydrogen atoms, and one is the univalent hydrocarbon group including the ether structure. The reason therefor is from the viewpoint of suppressing the battery resistance.

Examples of the compound satisfying the general formula (1) may include the below compound A and compound B. Incidentally, the compound satisfying the general formula (1) is not limited to these.

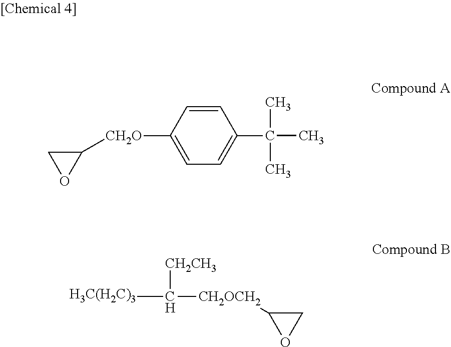

The modifier may be a polymer of the compound represented by the general formula (1). The polymer may be configured by only the compound represented by the general formula (1). For example, it may be a polymer configured by the compound A, may be a polymer configured by the compound B, and may be a polymer configured by the compound A and the compound B. Also, the polymer may be a polymer copolymerized with other monomers within the scope that does not significantly impair the effect of the present disclosure. Incidentally, in the present disclosure, the polymer of the compound represented by the general formula (1) refers to a compound configured by polymerizing two or more of the compound represented by the general formula (1). Also, in the coating layer, the presence of the compound represented by the general formula (1) and the polymer thereof can be confirmed by GC-MS.

Next, the general formula (2) will be explained. Incidentally, the halogen atom, the univalent hydrocarbon group and the univalent halogenated hydrocarbon group are the same as those in the general formula (1); thus, the descriptions herein are omitted.

The univalent silyl ether group is preferably a group represented by *—O—Si—(R²⁰)₃. In the group, R²⁰ is each independently a hydrogen atom or a univalent hydrocarbon group, and at least one of R²⁰ is the univalent hydrocarbon group. R²⁰ is preferably the univalent hydrocarbon group, the aliphatic hydrocarbon group or the alicyclic hydrocarbon group is preferable, and the aliphatic hydrocarbon group is more preferable. The aliphatic hydrocarbon group may be straight chain and may be branched chain, but is preferably branched chain. The univalent hydrocarbon group is the same as that in the general formula (1); thus, the description herein is omitted. Also, in the group, * represents a bonding part with Si in the general formula (2).

In the general formula (2), among R¹¹ to R¹⁴, it is preferable that at least two are the univalent silyl ether group, it is more preferable that at least three are the univalent silyl ether group, and it is further preferable that three are the univalent silyl ether group and one is the univalent hydrocarbon group. The reason therefor is from the viewpoint of suppressing the battery resistance.

Examples of the compound satisfying the general formula (2) may include the below compound C and compound D. Incidentally, the compound satisfying the general formula (2) is not limited to these.

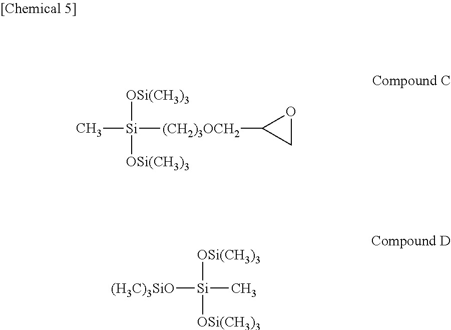

The modifier may be a polymer of the compound represented by the general formula (2). The polymer may be configured by only the compound represented by the general formula (2). For example, it may be a polymer configured by the compound C, and may be a polymer configured by the compound D. Also, the polymer may be a polymer copolymerized with other monomers within the scope that does not significantly impair the effect of the present disclosure. Incidentally, in the present disclosure, the polymer of the compound represented by the general formula (2) refers to a compound configured by polymerizing two or more of the compound represented by the general formula (2). Also, in the coating layer, the presence of the compound represented by the general formula (2) and the polymer thereof can be confirmed by GC-MS.

There are no particular limitations on the molecular weight of the modifier, but for example, it is 60 or more, may be 60 or more and 10000 or less, and may be 300 or more and 5000 or less. The reason therefor is from the viewpoint of suppressing the battery resistance.

Also, there are no particular limitations on the weight average molecular weight of the modifier, but for example, it is 60 or more, may be 60 or more and 10000 or less, and may be 300 or more and 5000 or less. The weight average molecular weight may be obtained by gel permeation chromatography (GPC) in terms of polystyrene.

The thickness (average thickness) of the coating layer is not particularly limited, and for example, it is 3 nm or more, may be 5 nm or more, and may be 10 nm or more. Meanwhile, the thickness of the coating layer is, for example, 100 nm or less, may be 50 nm or less, and may be 30 nm or less. The average thickness of the coating layer can be measured by, for example, using a transmission electron microscope (TEM). In specific, a cross-section SEM image of the coated sulfide solid electrolyte is obtained, and the thickness of the arbitrary points are measured to calculate the average value, and thereby the average thickness can be obtained.

The coverage of the coating layer is not particularly limited as long as at least a part of the surface of the sulfide solid electrolyte is covered, but the coverage is preferably high. The coverage is, for example, 50% or more, may be 70% or more, and may be 80% or more. Meanwhile, the coverage is, for example, 100% or less, may be 95% or less, and may be 90% or less. The coverage may be obtained by an X-ray photoelectron spectroscopy (XPS) measurement.

### (3) Coated Sulfide Solid Electrolyte

From the viewpoint of suppressing the battery resistance, in the coated sulfide solid electrolyte, the proportion of the modifier with respect to the sulfide solid electrolyte is preferably 12.5 mass % or less. The proportion of the modifier may be 10.0 mass % or less, and may be 8.0 mass % or less. Meanwhile, the proportion of the modifier is, for example, 1.0 mass % or more, may be 2.5 mass % or more, may be 3.0 mass % or more, and may be 5.0 mass % or more.

As shown in Examples described later, when the coating layer is arranged, the water resistance of the solid state battery (resistance increase rate) is significantly well compared to when the coating layer is not included (Comparative Examples 1 to 3). In specific, the battery resistance increase rate due to exposure time is significantly degraded. Meanwhile, although the reason is unclear, it was confirmed that the battery resistance tended to increase as the proportion of the modifier increased. For this reason, from the viewpoint of suppressing the battery resistance, the proportion of the modifier is preferably low.

### 2. Cathode Active Material Layer

The cathode active material layer in the present disclosure contains at least a cathode active material. Also, the cathode active material layer contains the above described coated sulfide solid electrolyte as the electrolyte. The coated sulfide solid electrolyte is in the same contents as those described in “1. Coated sulfide solid electrolyte”; thus, the descriptions herein are omitted.

Examples of the cathode active material may include an oxide active material. Examples of the oxide active material may include a rock salt bed type active material such as LiCoO₂, LiMnO₂, LiNiO₂, LiVO₂, and LiNi_{1/3}Co_{1/3}Mn_{1/3}O₂; a spinel type active material such as LiMn₂O₄, Li₄Ti₅O₁₂ and Li(Ni_{0.5}Mn_{1.5})O₄; and an olivine type active material such as LiFePO₄, LiMnPO₄, LiNiPO₄, and LiCoPO₄. Also, as the cathode active material, sulfur(S) may be used.

Also, the surface of the cathode active material may be, for example, covered with a Li-ion conductive oxide such as LiNbO₃. The thickness of the Li-ion conductive oxide is, for example, 1 nm or more and 30 nm or less.

Examples of the shape of the cathode active material may include a granular shape. The average particle size (D₅₀) of the cathode active material is not particularly limited, and for example, it is 10 nm or more, and may be 50 μm or less. The average particle size (D₅₀) is as described above.

Also, the cathode active material layer may contain at least one of a conductive auxiliary material and a binder, as required. Examples of the conductive auxiliary material may include a carbon material. Examples of the carbon material may include an artificial graphite, a graphite carbon fiber, a resin burned carbon, a thermally decomposed vapor-grown carbon, a coke, a mesocarbon microbead, a furfuryl alcohol resin burned carbon, a polyacene, a pitch-based carbon fiber, a vapor-grown carbon fiber, a natural graphite, and a non-graphitizable carbon. Examples of the binder may include a fluorine-based polymer such as polytetrafluoroethylene and polyvinylidene fluoride; a thermoplastic elastomer such as a butylene rubber and a styrene butadiene rubber; and various resins such as an acrylic resin, an acryl polyol resin, a polyvinyl acetal resin, a polyvinyl butyral resin and a silicone resin.

Also, the cathode active material layer may contain just the above described coated sulfide solid electrolyte as the electrolyte. Meanwhile, the cathode active material layer may contain an electrolyte (additional electrolyte) other than the above described coated sulfide solid electrolyte as the electrolyte. Examples of the additional electrolyte may include an inorganic solid electrolyte such as an oxide solid electrolyte and a halide solid electrolyte. The oxide solid electrolyte preferably contains oxygen (O) as a main component of the anion element. The halide solid electrolyte preferably contains halogen as a main component of the anion. Also, the cathode active material layer may contain the sulfide solid electrolyte (sulfide solid electrolyte not including the coating layer) as the additional electrolyte.

When the cathode active material layer contains the electrolyte other than the above described coated sulfide solid electrolyte, the proportion of the coated sulfide solid electrolyte with respect to all the electrolytes is, for example, 50 mass % or more, may be 70 mass % or more, and may be 90 mass % or more. Meanwhile, the proportion of the coated sulfide solid electrolyte with respect to all the electrolytes is, for example, 99 mass % or less, and may be 95 mass % or less.

The thickness of the cathode active material layer is not particularly limited, but for example, it is 0.1 μm or more and 1000 μm or less.

### 3. Anode Active Material Layer

The anode active material layer in the present disclosure contains at least an anode active material. Also, the anode active material layer contains the above described coated sulfide solid electrolyte as the electrolyte. The coated sulfide solid electrolyte is in the same contents as those described in “1. Coated sulfide solid electrolyte”; thus, the description herein is omitted.

Examples of the anode active material may include a Si-based active material, a carbon-based active material, and a Li-based active material. The Si-based active material is an active material containing a Si element.

Examples of the Si-based active material may include a simple substance Si, a Si alloy and a Si oxide. The Si alloy preferably contains a Si element as a main component. The proportion of the Si element in the Si alloy is, for example, 50 mol % or more and 99 mol % or less. Examples of the Si alloy may include a Si—Al-based alloy, a Si—Sn-based alloy, a Si—In-based alloy, a Si—Ag-based alloy, a Si—Pb-based alloy, a Si—Sb-based alloy, a Si—Bi-based alloy, a Si—Mg-based alloy, a Si—Ca-based alloy, a Si—Ge-based alloy, and Si—Pb-based alloy. The Si alloy may be a two component alloy, and may be a multi component alloy of three components or more. Examples of the Si oxide may include SiO.

The carbon active material is an inorganic active material containing a C element, and examples thereof may include graphite, hard carbon, and soft carbon. Also, the Li-based active material is an active material containing a Li element, and examples thereof may include a simple substance of Li and a Li alloy.

Examples of the shape of the anode active material may include a granular shape and a layer shape. The average particle size (D₅₀) of the anode active material is, for example, 10 nm or more and 50 μm or less. The average particle size (D₅₀) is as described above.

Also, the anode active material layer may contain at least one of a conductive auxiliary material and a binder, as required. Also, the anode active material layer may contain an electrolyte other than the above described coated sulfide solid electrolyte as the electrolyte. The conductive auxiliary material, the binder and the electrolyte are in the same contents as those described in “2. Cathode active material layer”.

The thickness of the anode active material layer is not particularly limited, but for example, it is 0.1 μm or more and 1000 μm or less.

### 4. Solid Electrolyte Layer

The solid electrolyte layer in the present disclosure is a layer arranged between the cathode active material layer and the anode active material layer. Also, the solid electrolyte layer contains the above described coated sulfide solid electrolyte as the electrolyte. The coated sulfide solid electrolyte is in the same contents as those described in “1. Coated sulfide solid electrolyte”; thus, the description herein is omitted.

Also, the solid electrolyte layer may contain a binder as required. The binder is in the same contents as those described in “2. Cathode active material layer”. Also, the solid electrolyte layer may contain an electrolyte other than the above described coated sulfide solid electrolyte as the electrolyte. The electrolyte is in the same contents as those described in “2. Cathode active material layer”.

The thickness of the solid electrolyte layer is not particularly limited, but for example, it is 0.1 μm or more and 1000 μm or less.

### 5. Solid State Battery

The solid state battery in the present disclosure usually includes a cathode current collector for collecting electrons of the cathode active material layer and an anode current collector for collecting electrons of the anode active material layer. Examples of the material for the cathode current collector may include SUS, aluminum, nickel, iron, titanium, and carbon. Meanwhile, examples of the material for the anode current collector may include SUS, copper, nickel, and carbon.

Also, the solid state battery in the present disclosure may include an outer package for storing the above described members. Examples of the outer package may include a laminate type outer package and a case type outer package. Also, the solid state battery in the present disclosure may include a restraining jig that applies a restraining pressure of a thickness direction to the above described members. As the restraining jig, known jigs may be used. The restraining pressure is, for example, 0.1 MPa or more and 50 MPa or less, and may be 1 MPa or more and 20 MPa or less.

The kind of the solid state battery in the present disclosure is not particularly limited, but is typically a lithium ion secondary battery. The application of the solid state battery is not particularly limited, and examples thereof may include a power source for vehicles such as hybrid electric vehicles (HEV), plug-in hybrid electric vehicles (PHEV), battery electric vehicles (BEV), gasoline-fueled automobiles and diesel powered automobiles. In particular, it is preferably used as a power source for driving hybrid electric vehicles (HEV), plug-in hybrid electric vehicles (PHEV), and battery electric vehicles (BEV). Also, the solid state battery in the present disclosure may be used as a power source for moving bodies other than vehicles (such as rail road transportation, vessel and airplane), and may be used as a power source for electronic products such as information processing equipment.

### B. Method for Producing Solid State Battery

The present disclosure also provides a method for producing the above described solid state battery, the method including: a preparing step of preparing the coated sulfide solid electrolyte; and a layer forming step of forming the cathode active material layer, the anode active material layer, and the solid electrolyte layer using the coated sulfide solid electrolyte, wherein the layer forming step is performed under an environment with a dew point temperature of −50° C. or more.

### 1. Preparing Step

The preparing step is a step of preparing the coated sulfide solid electrolyte. In the preparing step, the above described coated sulfide solid electrolyte may be prepared by purchasing it, and may be prepared by fabricating it by oneself. The coated sulfide solid electrolyte may be fabricated in the following manner, for example.

First, a compound containing a Li element, a compound containing a S element, and a compound containing a P element are mixed in an arbitrary ratio to obtain a raw material composition. Also, the raw material composition may contain a compound containing a halogen element.

Examples of the compound containing a Li element may include a sulfide of Li such as Li₂S, and an oxide of Li such as Li₂O. Examples of the compound containing a P element may include a simple substance of P, an oxide of P such as P₂O₅, and a sulfide of P such as P₂S₅. The compound containing a S element may be a simple substance(S), and may be a sulfide. Examples of the compound containing a halogen element may include a halogenated lithium such as LiF and LiCl.

Next, the raw material composition is mixed with a complexing agent such as tetramethyl ethylene diamine, and dried. Thereby, an amorphous sulfide solid electrolyte is prepared. By mixing with the complexing agent, the later described modifier may be more easily adhered to the surface of the sulfide solid electrolyte. Also, by burning the amorphous sulfide solid electrolyte at a temperature of the crystallization temperature or more, the crystalline sulfide solid electrolyte is prepared.

Then, the coating layer is formed on the surface of the sulfide solid electrolyte using the above described modifier. Thereby, the coated sulfide solid electrolyte is fabricated. The coating layer is formed by mixing the sulfide solid electrolyte, the above described modifier, and a solvent such as toluene, and drying thereof.

### 2. Layer Forming Step

The layer forming step is a step of forming the cathode active material layer, the anode active material layer, and the solid electrolyte layer, using the coated sulfide solid electrolyte. In particular, in the method for producing the solid state battery in the present disclosure, the layer forming step is performed under an environment with a dew point temperature of −50° C. or more.

The sulfide solid electrolyte is preferably used under an environment with sufficiently little moisture amount in order to avoid the reaction with the moisture in the air. In this point, maintaining such an environment is costly. In contrast, the coated sulfide solid electrolyte in the present disclosure has improved water resistance by the coating layer, and thus it can be used under the environment with comparatively high moisture amount. As a result, the production cost of the solid state battery can be reduced.

The dew point temperature is not particularly limited as long as it is −50° C. or more. The dew point temperature may be −45° C. or more, may be −40° C. or more, and may be −35° C. or more. Meanwhile, the dew point temperature is, for example, −30° C. or less.

Each layer described above may be formed by, for example, a coating method using a slurry containing the above described coated sulfide solid electrolyte.

### 3. Solid State Battery

The solid state battery produced by the above described steps is in the same contents as those described in “A. Solid state battery”; thus, the descriptions herein are omitted.

Incidentally, the present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Example 1

### <Production of Modified Sulfide Solid Electrolyte (Coated Sulfide Solid Electrolyte)>

Under a nitrogen atmosphere, 0.59 g of lithium sulfide, 0.95 g of phosphorous pentasulfide, 0.19 g of lithium bromide, and 0.28 g of lithium iodide were introduced to Schlenk with stirring bar (capacity: 100 mL). After rotating the stirring bar, 20 mL of complexing agent tetramethyl ethylene diamine (TMEDA) was added, and agitating thereof was continued for 12 hours. Thereby, a complex containing compound was obtained. The complex containing compound was dried under vacuum at a room temperature (23° C.) to obtain a powder complex. The powder complex was heated at 120° C. for 2 hours under vacuum to obtain an amorphous sulfide solid electrolyte.

The amorphous sulfide solid electrolyte was heated at 140° C. for 2 hours under vacuum to obtain a crystalline sulfide solid electrolyte.

Under a nitrogen atmosphere, 3 g of the crystalline sulfide solid electrolyte and 22 g of toluene were added to Schlenk with a stirring bar (capacity: 100 mL), and agitated. Thereby, a slurry was obtained. To the slurry, 0.075 g of a modifier (epoxy compound) was added, and agitated for 10 minutes. After that, the slurry was vacuum-dried to remove toluene. Thereby, a modified sulfide solid electrolyte was obtained. As the epoxy compound, 1, 1, 1, 3, 5, 5, 5, -Heptametyhl-3-(3-glycidyloxypropyl)trisiloxane was used. Incidentally, this epoxy compound is referred to as modifier α. Incidentally, the modifier α corresponds to the compound C. Also, the amount of the epoxy compound added was 2.5 parts by mass with respect to 100 parts by mass of the crystalline sulfide solid electrolyte. Incidentally, the modified sulfide solid electrolyte was produced under an environment with sufficiently low humidity such as a dew point −70° C., and stored.

### <Production of Cathode>

A cathode active material (LiNi_{1/3}CO_{1/3}Mn_{1/3}O₂) 80.0 g, the modified sulfide solid electrolyte 9.51 g, and the conductive auxiliary material (VGCF; from SHOWA DENKO K.K.) 2.5 g were gathered in Filmix container. After that, a binder solution (solution containing styrene butadiene rubber) and a solvent (tetralin) 32.21 g were added to the Filmix container. Thereby, a raw material composition for cathode of which solid concentration was 69 mass % was obtained. Incidentally, the concentration of the styrene butadiene rubber in the binder solution was 5 mass % with respect to the whole solution. The raw material composition for cathode was kneaded using a kneading device (Filmix) to obtain a cathode composition. The cathode composition was applied on a surface of a cathode current collector (Al foil) in a film shape by a blade coating method using an applicator, and heated at 100° C. for 30 minutes. Thereby, a cathode including a cathode current collector and a cathode active material layer was obtained.

### <Production of Anode Layer>

An anode active material (simple substance of Si) 18.6 g, the modified sulfide solid electrolyte 8.69 g, a binder solution (solution containing styrene butadiene rubber) and a solvent (diisobutyl ketone) were added to a Filmix container. Thereby, a raw material composition for anode of which solid concentration was 43 mass % was obtained. Incidentally, the concentration of the styrene butadiene rubber in the binder solution was 5 mass % with respect to the whole solution. The raw material composition for anode was kneaded by a kneading device (Filmix) to obtain an anode composition. Incidentally, the kneading was performed using a PC wheel for high shearing in the condition of peripheral speed 5 m/s to 30 m/s. The anode composition was applied on both surfaces of an anode current collector (Ni foil) in a film shape by a blade coating method using an applicator, and heated at 100° C. for 30 minutes. Thereby, an anode in which the anode active material layers were arranged on both surfaces of the anode current collector was obtained.

### <Production of Transferring Member>

The modified sulfide solid electrolyte 40 g, a binder solution (solution including acrylate butadiene rubber and hexane) 8.00 g, heptane 25.62 g and dibutyl ether 8.00 g were mixed and kneaded by an ultrasonic homogenizer. Thereby, a solid electrolyte layer composition was obtained. Incidentally, the concentration of acrylate butadiene rubber in the binder solution was 5 mass % with respect to the whole solution. The solid electrolyte layer composition was applied on a surface of a substrate (Al foil) in a film shape by a blade coating method using an applicator, and heated at 100° C. for 30 minutes. Thereby, a transferring member including the substrate and the solid electrolyte layer was produced.

### <Production of Solid State Battery>

The transferring member was arranged on both surfaces of the anode so that the anode active material layer and the solid electrolyte layer faced to each other, and pressed to obtain an anode structure body. After that, the cathode was arranged on both surfaces of the anode structure body so that the solid electrolyte layer and the cathode active material layer faced to each other, and thereby an electrode layered body was obtained. The electrode layered body was pressed at the linear pressure of 4 ton/cm by a roll-pressing machine. Thereby, a solid state battery (evaluation battery) in which the solid electrolyte layer and the cathode were arranged on both sides of the anode was obtained. Incidentally, design capacity of the battery was 0.3 Ah.

### Example 2 and Example 3

Produced coated sulfide solid electrolyte was exposed to an environment with a dew point of −30° C. for 3 h or 5h, and then vacuum-dried at 80° C. for 4 h. An evaluation battery was respectively produced in the same manner as in Example 1 except that the coated sulfide solid electrolyte to which this treatment was performed was respectively used.

### Example 4 to Example 6

An evaluation battery was respectively produced in the same manner as in Example 1 to Example 3, except that 2-Ethylhexyl Glycidyl Ether (modifier β) was used as the modifier. Incidentally, the modifier β corresponds to the compound B.

### Example 7 to Example 9

An evaluation battery was respectively produced in the same manner as in Example 1 to Example 3, except that 4-tert-Butylphenyl Glycidyl Ether (modifier γ) was used as the modifier. Incidentally, the modifier γ corresponds to the compound A.

### Example 10 to Example 18

An evaluation battery was respectively produced in the same manner as in Example 1 to Example 9 except that the amount of the modifier was changed to the amount of 5 parts by mass with respect to 100 parts by mass of the crystalline sulfide solid electrolyte and the coated sulfide solid electrolyte was produced.

### Example 19 to Example 27

An evaluation battery was respectively produced in the same manner as in Example 1 to Example 9 except that the amount of the modifier was changed to the amount of 10 parts by mass with respect to 100 parts by mass of the crystalline sulfide solid electrolyte and the coated sulfide solid electrolyte was produced.

### Example 28 to Example 36

An evaluation battery was respectively produced in the same manner as in Example 1 to Example 9 except that the amount of the modifier was changed to the amount of 15 parts by mass with respect to 100 parts by mass of the crystalline sulfide solid electrolyte and the coated sulfide solid electrolyte was produced.

### Example 37 to Example 45

An evaluation battery was respectively produced in the same manner as in Example 1 to Example 9 except that the amount of the modifier was changed to the amount of 20 parts by mass with respect to 100 parts by mass of the crystalline sulfide solid electrolyte and the coated sulfide solid electrolyte was produced.

### Comparative Example 1

An evaluation battery was produced in the same manner as in Example 1 except that the cathode, the anode, and the solid electrolyte layer were produced using the crystalline sulfide solid electrolyte before adding the modifier produced in Example 1.

### Comparative Example 2 and Comparative Example 3

The sulfide solid electrolyte in Comparative Example 1 was exposed to the environment with a dew point of −30° C. for 3 h or 5h, and then vacuum-dried at 80° C. for 4h. An evaluation battery was produced in the same manner as in Comparative Example 1 except that the sulfide solid electrolyte to which this treatment was performed was used.

### [Evaluation 1]

### <Battery Resistance Evaluation>

Charge and discharge with the below conditions were performed to each of the produced evaluation batteries for four cycles, and the battery resistance after four cycles was respectively calculated for evaluation. The results are shown in Table 1 and Table 2.

Charge and discharge conditions: CCCV charge and discharge, upper limit voltage 4.25 V, lower limit voltage 2.87 V, 1 C

Also, the battery resistance in the case not exposed to the environment with a dew point temperature of −30° C. was used as a reference, and the resistance increase rate by exposure time was calculated. The results are shown in Table 1 and Table 2.

TABLE 1

| | | | Proportion | | |
|---|---|---|---|---|---|
| | | Exposure | of | Battery | Resistance |
| | | time | modifier | resistance | increase |
| | Modifier | (h) | (mass %) | (Ω · cm²) | rate |
| Example 1 | α | 0 | 2.5 | 40 | 1.00 |
| Example 2 | α | 3 | 2.5 | 53 | 1.33 |
| Example 3 | α | 5 | 2.5 | 57 | 1.43 |
| Example 4 | β | 0 | 2.5 | 39 | 1.00 |
| Example 5 | β | 3 | 2.5 | 55 | 1.41 |
| Example 6 | β | 5 | 2.5 | 57 | 1.46 |
| Example 7 | γ | 0 | 2.5 | 40 | 1.00 |
| Example 8 | γ | 3 | 2.5 | 54 | 1.35 |
| Example 9 | γ | 5 | 2.5 | 58 | 1.45 |
| Example 10 | α | 0 | 5 | 39 | 1.00 |
| Example 11 | α | 3 | 5 | 48 | 1.23 |
| Example 12 | α | 5 | 5 | 52 | 1.33 |
| Example 13 | β | 0 | 5 | 40 | 1.00 |
| Example 14 | β | 3 | 5 | 48 | 1.20 |
| Example 15 | β | 5 | 5 | 51 | 1.28 |
| Example 16 | γ | 0 | 5 | 40 | 1.00 |
| Example 17 | γ | 3 | 5 | 49 | 1.23 |
| Example 18 | γ | 5 | 5 | 55 | 1.38 |
| Example 19 | α | 0 | 10 | 52 | 1.00 |
| Example 20 | α | 3 | 10 | 64 | 1.23 |
| Example 21 | α | 5 | 10 | 67 | 1.29 |
| Example 22 | β | 0 | 10 | 53 | 1.00 |
| Example 23 | β | 3 | 10 | 65 | 1.23 |
| Example 24 | β | 5 | 10 | 67 | 1.26 |
| Example 25 | γ | 0 | 10 | 54 | 1.00 |
| Example 26 | γ | 3 | 10 | 64 | 1.19 |
| Example 27 | γ | 5 | 10 | 66 | 1.22 |

Modifier α: 1,1,1,3,5,5,5-Heptamethyl-3-(3-glycidyloxypropyl)trisiloxane
Modifier β: 2-Ethylhexyl Glycidyl Ether
Modifier γ: 4-tert-Butylphenyl Glycidyl Ether

TABLE 2

| | | | Proportion | | |
|---|---|---|---|---|---|
| | | Exposure | of | Battery | Resistance |
| | | time | modifier | resistance | increase |
| | Modifier | (h) | (mass %) | (Ω · cm²) | rate |
| Example 28 | α | 0 | 15 | 103 | 1.00 |
| Example 29 | α | 3 | 15 | 106 | 1.03 |
| Example 30 | α | 5 | 15 | 111 | 1.08 |
| Example 31 | β | 0 | 15 | 104 | 1.00 |
| Example 32 | β | 3 | 15 | 105 | 1.01 |
| Example 33 | β | 5 | 15 | 110 | 1.06 |
| Example 34 | γ | 0 | 15 | 102 | 1.00 |
| Example 35 | γ | 3 | 15 | 103 | 1.01 |
| Example 36 | γ | 5 | 15 | 113 | 1.11 |
| Example 37 | α | 0 | 20 | 124 | 1.00 |
| Example 38 | α | 3 | 20 | 126 | 1.02 |
| Example 39 | α | 5 | 20 | 131 | 1.06 |
| Example 40 | β | 0 | 20 | 123 | 1.00 |
| Example 41 | β | 3 | 20 | 123 | 1.00 |
| Example 42 | β | 5 | 20 | 130 | 1.06 |
| Example 43 | γ | 0 | 20 | 120 | 1.00 |
| Example 44 | γ | 3 | 20 | 128 | 1.07 |
| Example 45 | γ | 5 | 20 | 129 | 1.08 |
| Comp. Ex. 1 | — | 0 | 0 | 38 | 1.00 |
| Comp. Ex. 2 | — | 3 | 0 | 56 | 1.47 |
| Comp. Ex. 3 | — | 5 | 0 | 150 | 3.95 |

Modifier α: 1,1,1,3,5,5,5,-Heptametyhl-3-(3-glycidyloxypropyl)trisiloxane
Modifier β: 2-Ethylhexyl Glycidyl Ether
Modifier γ: 4-tert-Butylphenyl Glycidyl Ether

As shown in Table 1 and Table 2, the resistance increase rate was suppressed in all Examples compared to Comparative Examples, and it was confirmed that the deterioration due to moisture was suppressed in the solid state battery in the present disclosure. Also, as the proportion of the modifier in the coated sulfide solid electrolyte increased, the battery resistance itself increased although the resistance increase rate was suppressed. Therefore, it was suggested that the proportion of the modifier was preferably little from the viewpoint of suppressing the battery resistance.

### REFERENCE SINGS LIST

1 cathode active material layer
2 anode active material layer
3 solid electrolyte layer
4 cathode current collector
5 anode current collector
10 solid state battery

What is claimed is:

1. A solid state battery comprising a cathode active material layer, an anode active material layer, and a solid electrolyte layer arranged between the cathode active material layer and the anode active material layer, wherein
the cathode active material layer, the anode active material layer, and the solid electrolyte layer contain a coated sulfide solid electrolyte as an electrolyte;
the coated sulfide solid electrolyte includes a sulfide solid electrolyte containing at least a Li element, a S element, and a P element, and a coating layer that covers a surface of the sulfide solid electrolyte and contains a modifier; and
the modifier is at least one kind of, a compound represented by the below general formula (1), a compound represented by the below general formula (2), a polymer of the compound represented by the below general formula (1), and a polymer of the compound represented by the below general formula (2). 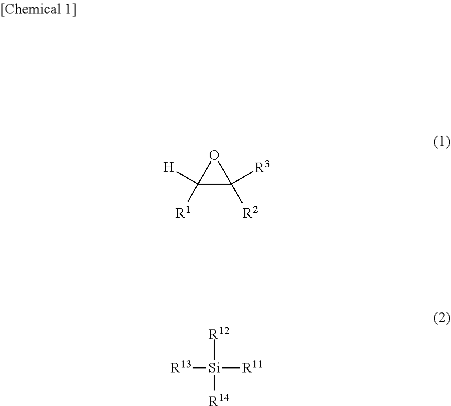
In the formula (1), R¹ to R³ are each independently a hydrogen atom, a halogen atom, a univalent hydrocarbon group or a univalent halogenated hydrocarbon group, at least one of R¹ to R³ is a univalent hydrocarbon group or a univalent halogenated hydrocarbon group, and at least one of R¹ to R³ includes an ether structure.
In the formula (2), R¹¹ to R¹⁴ are each independently a hydrogen atom, a halogen atom, a univalent silyl ether group, a univalent hydrocarbon group or a univalent halogenated hydrocarbon group, and at least one of R¹¹ to R¹⁴ is a silyl ether group.

2. The solid state battery according to claim 1, wherein a proportion of the modifier with respect to the sulfide solid electrolyte is 12.5 mass % or less.

3. The solid state battery according to claim 1, wherein a proportion of the modifier with respect to the sulfide solid electrolyte is 10.0 mass % or less.

4. The solid state battery according to claim 1, wherein the modifier is at least one of the compound represented by the general formula (1) and the polymer of the compound represented by the general formula (1), among R¹ to R³, two are the hydrogen atom, and one is the univalent hydrocarbon group including the ether structure.

5. The solid state battery according to claim 1, wherein the modifier is at least one of the compound represented by the general formula (2) and the polymer of the compound represented by the general formula (2), among R¹¹ to R¹⁴, three are the univalent silyl ether group, and one is the univalent hydrocarbon group.

6. The solid state battery according to claim 1, wherein the modifier is at least one kind of, the below compound A, the below compound B, the below compound C, the below compound D, a polymer including at least one of the below compound A and the below compound B, and a polymer including at least one of the below compound C and the below compound D.

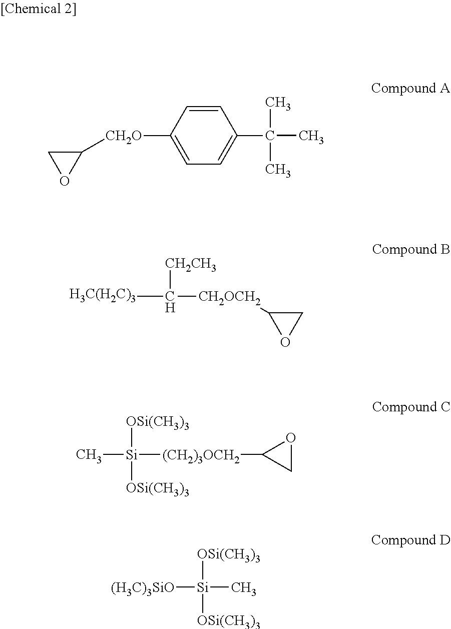

7. The solid state battery according to claim 6, wherein the modifier is the compound A, the compound B or the compound C.

8. The solid state battery according to claim 1, wherein a molecular weight or a weight average molecular weight of the modifier is 60 or more.

9. The solid state battery according to claim 1, wherein, in each of the cathode active material layer, the anode active material layer, and the solid electrolyte layer, a proportion of the coated sulfide solid electrolyte with respect to a total of the electrolyte is 50 mass % or more and 100 mass % or less.

10. A method for producing the solid state battery according to claim 1, the method comprising:
a preparing step of preparing the coated sulfide solid electrolyte; and
a layer forming step of forming the cathode active material layer, the anode active material layer, and the solid electrolyte layer, using the coated sulfide solid electrolyte, wherein
the layer forming step is performed under an environment with a dew point temperature of −50° C. or more.

11. The method for producing the solid state battery according to claim 10, wherein the layer forming step is performed under an environment with a dew point temperature of −30° C. or less.
